(19) United States
(12) Patent Application Publication
(10) Pub. No.: US 2024/0233371 A1
(43) Pub. Date: Jul. 11, 2024

(54) DEPTH-STAGE DEPENDENT AND HYPERPARAMETER-ADAPTIVE LIGHTWEIGHT CONVOLUTIONAL NEURAL NETWORK-BASED MODEL FOR RAPID ROAD CRACK DETECTION

(71) Applicants: Hohai University, Nanjing (CN); Jiangxi University of Science and Technology, Ganzhou (CN); JSTI Group Co., Ltd, Nanjing (CN)

(72) Inventors: Maosen CAO, Nanjing (CN); Ronghua FU, Nanjing (CN); Tongfa DENG, Ganzhou (CN); Yufeng ZHANG, Nanjing (CN); Xiangdong QIAN, Nanjing (CN); Dragoslav Sumarac, Nanjing (CN); Shuai LI, Nanjing (CN); Kai ZHU, Nanjing (CN)

(73) Assignees: Hohai University, Nanjing (CN); Jiangxi University of Science and Technology, Ganzhou (CN); JSTI Group Co., Ltd, Nanjing (CN)

(21) Appl. No.: 18/540,915

(22) Filed: Dec. 15, 2023

(30) Foreign Application Priority Data
Jan. 5, 2023 (CN) 202310012020.X

(51) Int. Cl. G06V 20/10; G06N 3/0464

(52) U.S. Cl. CPC G06V 20/182; G06N 3/0464

(57) ABSTRACT

A depth-stage dependent and hyperparameter-adaptive lightweight CNN-based model, named Faster R-Stair, which relates to the field of concrete crack detection technology. The structure of the backbone in this model is depth-stage dependent, which includes suitable structures in different depths. The backbone is also hyperparameter-adaptive. The basic components in different depths of the backbone have variations according to the adjustment of some hyperparameters. The proposed model in this embodiment has the advantages of high convergence speed in training, fast detection speed and high accuracy when used in crack detection.

### CROSS REFERENCE TO RELATED APPLICATION

This application is based upon and claims foreign priority to Chinese Patent Application No. 202310012020.X, filed on Jan. 5, 2023, the entire content of which is incorporated herein by reference.

### TECHNICAL FIELD

This disclosure relates to the field of road crack detection technology, specifically a method for fast detecting road cracks in images using the depth-stage dependent and hyperparameter-adaptive lightweight convolutional neural network (CNN)-based model.

### BACKGROUND

The general CNN-based models originated from the computer science and were directly used for detecting road cracks, with less optimization. They can identify hundreds or thousands of object types. However, the road cracks, which are often concrete cracks, have handful types. These models are large in size, resulting in a long training time, low efficiency and waste of hardware resources for crack detection. The general CNN-based models typically have the similar structures in different depths. In contrast, the model proposed in the present disclosure is developed through extensive studies specifically for the problem of rapid concrete crack detection, resulting in a novel CNN-based model. This model has specific and appropriate structures for different depths. Additionally, the structure of the model is hyperparameter-adaptive. The model's structure changes accordingly with the adjustment of some certain hyperparameters. The model in the present disclosure exhibits advantages in terms of efficiency and detection accuracy for road crack detection.

### SUMMARY

A method for fast detecting road cracks in images using the depth-stage dependent and hyperparameter-adaptive lightweight CNN-based model, comprising the following steps:

Step 1: The original images of road surface are collected and a dataset is established, including a training set and a validation set.

Step 2: The images from the dataset are inputted into the backbone to obtain feature maps.

Step 3: The feature maps obtained from the backbone are inputted to the region proposal network (RPN) to generate proposals. The proposals are projected onto the feature maps outputted by backbone to obtain corresponding feature matrices.

Step 4: The feature matrix is passed through the region of interest (ROI) head to output the predicted bounding boxes of the road cracks in the feature maps.

Step 5: The predicted bounding boxes of the road cracks in the feature maps are mapped back to the original image using post-processing to obtain the positions and types of road cracks in the original image.

Step 6: In the training phase, the loss is incorporated into the optimization function to update the network parameters until the network model converges.

Step 7: The road images to be detected are input into the well-trained model to localize and classify the cracks in the images.

The structure of the backbone in Step 2 is depth-stage dependent, which includes suitable structures in different depths: convolutional layer, stair1, a convolution block attention module (CBAM), stair2, another CBAM, and stair3.

The structure of the backbone in Step 2 is hyperparameter-adaptive, the basic components in stair1 and stair2 have some variations according to the adjustment of some hyperparameters.

The stair1 has two variations as follows: when the expansion factor is 1, the input feature maps go through an inverted residual structure with convolutions; when the expansion factor is not 1, the input feature maps go through a convolutional operation.

The stair2 has two variations as follows: when the kernel stride is 1, the channels of the input feature maps are split into two equal parts using the split operation. One part goes through an inverted residual structure with depth-wise separable convolutions, while the other part remains unchanged. After that, the two sets of channels are concatenated and then subjected to the shuffle operation; when the kernel stride is 2, the channels of the input feature maps are replicated into three copies. One copy goes through an inverted residual structure. Another copy goes through a depth-wise separable convolution followed by dimension reduction. The last copy goes through a max pooling operation followed by dimension reduction. Finally, the three sets of dimension-reduced channels are concatenated and then subjected to the shuffle operation.

The stair3 consists of a residual structure consisting of depth separable convolution and efficient channel attention (ECA).

During the process of the feature extraction of the backbone, the data normalized by batch normalization layer undergoes normalization processing.

During the process of the feature extraction of the backbone, the data activated by ReLU6 activation function undergoes nonlinear processing.

During the process of the feature extraction of the backbone, the data activated by Hardswish activation function undergoes nonlinear processing.

During the process of the feature extraction of the backbone, the data undergoes cross-channel interaction using the ECA, obtaining enhanced feature maps of road cracks.

During the process of the feature extraction of the backbone, the channel attention module of the CBAM is used to compress the channel dimensions of the input feature maps and merge them by element-wise summation to generate the channel attention map.

During the process of the feature extraction of the backbon, the spatial attention module of the CBAM is used to obtain feature maps that contain more information about important features.

The RPN (Region Proposal Network) structure in Step 3 includes an anchor generator and RPN head.

The anchor generator generates multiple sets of anchor boxes and assigns the anchor boxes to the original image.

The RPN head structure includes a 3×3 convolutional layer, two parallel 1×1 convolutional layer, and a ReLU activation function.

The training processes for the RPN head include passing the feature map obtained from the backbone-Stair through a 3×3 convolutional layer. The output of the 3×3 convolutional layer is then passed through the two parallel 1×1 convolutional layers and a ReLU activation function. The output of the two parallel convolution layers contains the target scores and regression parameters for all anchor boxes corresponding to each pixel point in the feature map.

The anchor boxes obtained from anchor generator are adjusted using the regression parameters obtained from RPN head, resulting in proposals.

The proposals are filtered using non-maximum suppression or other algorithms, then the filtered proposals are projected onto the feature maps output by the backbone to obtain corresponding feature matrices.

The RPN head structure calculates losses, including classification loss and regression loss.

The feature matrices are pooled and transformed into 7×7-sized feature maps in step 4.

The fully connected layer structure in Step 4 consists of two concatenated fully connected layers (FC1, FC2), where the flattened feature maps, obtained from FC1 and FC2, pass through the two fully connected layers and then into two parallel fully connected layers (FC3, FC4) for predicting crack class scores and regression parameters for each proposal. Similar to the steps in RPN, the losses of the fully connected layers should be calculated.

The proposals generated in step 3 are adjusted to be the final predicted bounding boxes using regression parameters predicted by the fully connected layer FC4.

The predicted results of the model are post-processed in step 5 to map the detected results back to the original images.

The internal parameters of the network are optimized using the Adam algorithm.

### BRIEF DESCRIPTION OF THE DRAWINGS

FIG. 1 depicts the process of using the Faster R-Stair model for detecting road-surface cracks in the Example 1 of the present embodiment.

FIG. 2 displays the structure of the Faster R-Stair in the Example 1 of the present embodiment.

FIG. 3A depicts the structure of the backbone-Stair in the Faster R-Stair in the example 1 of the present embodiment.

FIG. 3B depicts the structure of stair1 in the backbone-Stair of the Faster R-Stair in the example 1 of the present embodiment.

FIG. 3C depicts the structure of stair2 in the backbone-Stair of the Faster R-Stair in the example 1 of the present embodiment.

FIG. 3D depicts the structure of stair3 in the backbone-Stair of the Faster R-Stair in the example 1 of the present embodiment.

FIG. 4 is displays the crack detection results using the Faster R-Stair in the example 1 of the present embodiment.

### DETAILED DESCRIPTION OF THE EMBODIMENTS

To better understand the technical solution of the present embodiment, the embodiment will be described in detail in conjunction with the accompanying drawings and specific embodiments. The example 1 are provided for the purpose of illustrating the technical solution of the present embodiment more clearly and should not be construed as limiting the scope of the embodiment.

### Example 1

Table 1 displays the computer system and environmental configuration in the example 1 of the present embodiment.

TABLE 1
Computer system and environmental configuration

| Platform | Parameters |
|---|---|
| System | Windows 10 |
| | Intel(R) Xeon(R) Gold |
| CPU | 5222 CPU @ 3.80 GHz |
| | 3.79 GHz |
| GPU | NVIDIA Quadro P2200 |
| Memory | 64.0 GB |
| Environment | Anaconda3 |
| | CUDA10.2 |
| | Python3.6 |
| | PyTorch |

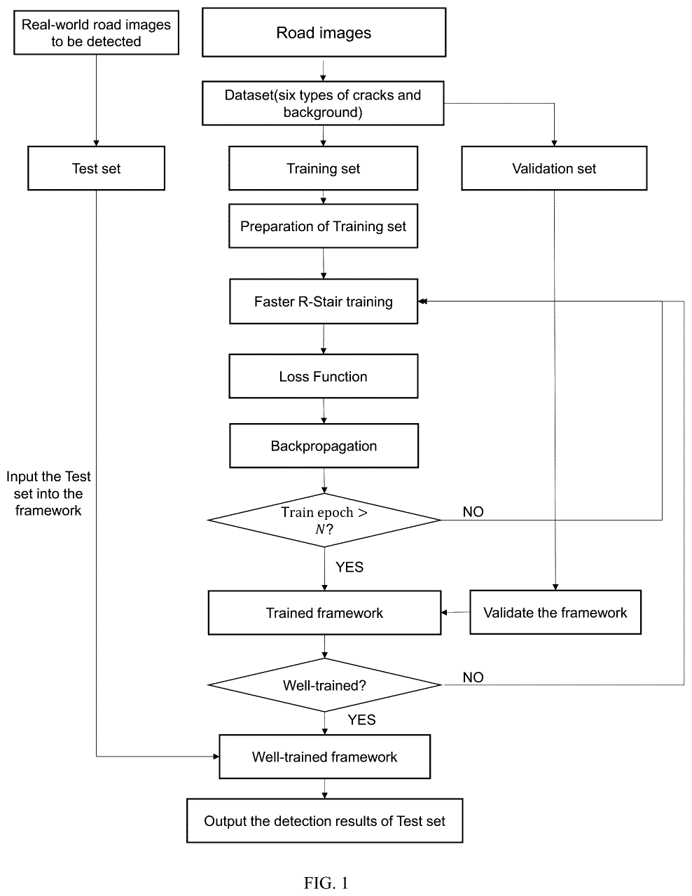

As depicted in FIG. 1, the present embodiment provides a depth-stage dependent and hyperparameter-adaptive lightweight CNN-based model for road crack detection, named Faster R-Stair. The embodiment comprises the following steps:

Step 1: The original images of road surface are collected and a dataset is established, including a training set and a validation set.

Step 2: The images from the dataset are inputted into the backbone to obtain feature maps.

Step 3: The feature maps obtained from the backbone are inputted to the region proposal network (RPN) to generate proposals. The proposals are projected onto the feature maps outputted by backbone to obtain corresponding feature matrices.

Step 4: The feature matrix is passed through the region of interest (ROI) head to output the predicted bounding boxes of the road cracks in the feature maps.

Step 5: The predicted bounding boxes of the road cracks in the feature maps are mapped back to the original image using post-processing to obtain the positions and types of road cracks in the original image.

Step 6: In the training phase, the loss is incorporated into the optimization function to update the network parameters until the network model converges.

Step 7: The road images to be detected are input into the well-trained model to localize and classify the cracks in the images.

In step 1, after collecting the road images, the training set and validation set are manually annotated. The annotations include seven types of cracks in roads: TransverseCrack, VerticalCrack, ObliqueCrack, MeshCrack, IrregularCrack, Hole. The training set and validation set comprise these six types of cracks along with corresponding pattern labels indicating the crack types.

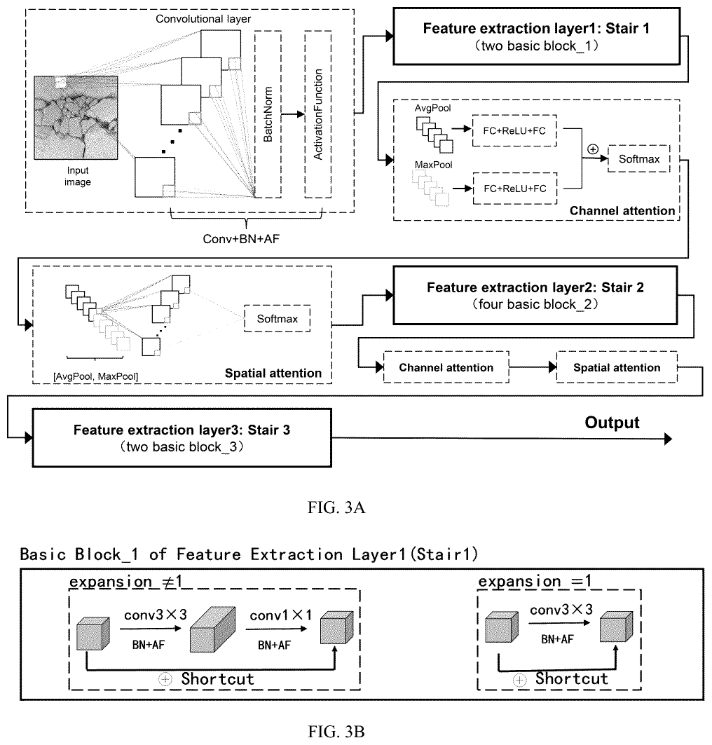

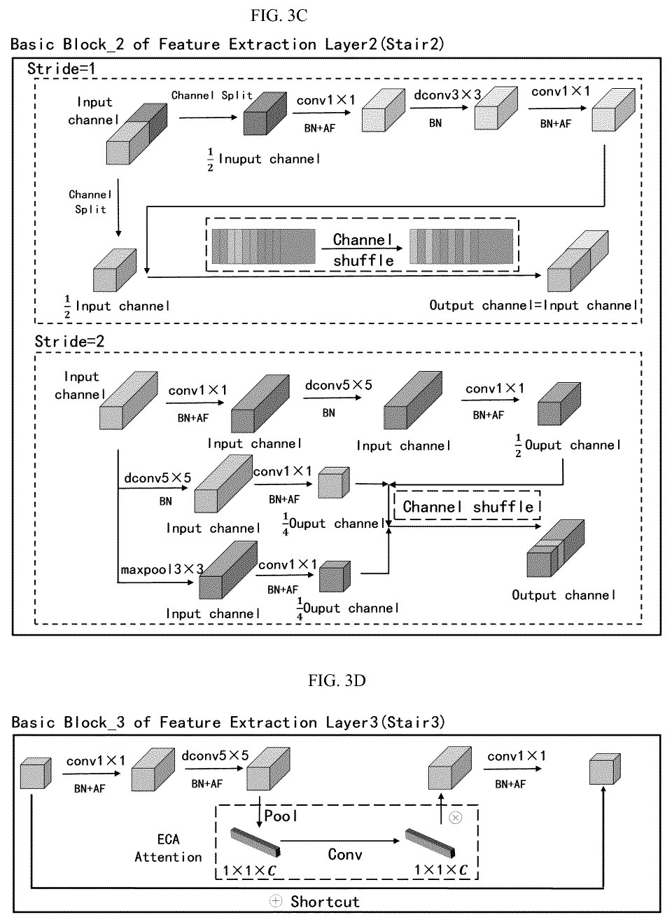

In step 2, the structure of the backbone-Stair is depicted in FIG. 3A. It includes the following components: a convolutional layer, stair1, a convolution block attention module (CBAM), stair2, another CBAM, and stair3. The details of the structure and inner parameters are displayed in Table 2.

TABLE 2
Structure and parameters in backbone-Stair

| Feature | Input(Height, | | | | | |
|---|---|---|---|---|---|---|
| extraction | Width, | | Expansion | Output | Activation | |
| layer | channel) | Operator | factor | channel | function | Stride |
| Stair1 | 224 × 224 × 3 | conv2d | \ | 16 | HS | 2 |
| | 112 × 112 × 16 | Basic block_1 | 2 | 24 | RE | 2 |
| | 56 × 56 × 24 | Basic block_1 | 1 | 24 | RE | 1 |
| | Channel Attention | | | | | |
| | Spatial Attention | | | | | |
| Stair2 | 56 × 56 × 24 | Basic block_2 | \ | 48 | RE | 2 |
| | 28 × 28 × 48 | Basic block_2 | 1 | 48 | HS | 1 |
| | 28 × 28 × 48 | Basic block_2 | \ | 96 | HS | 2 |
| Stair3 | 14 × 14 × 96 | Basic block_2 | 1 | 96 | HS | 1 |
| | Channel Attention | | | | | |
| | Spatial Attention | | | | | |
| | 14 × 14 × 96 | Basic block_3 | 6 | 96 | HS | 2 |
| | 14 × 14 × 96 | Basic block_3 | 6 | 96 | HS | 1 |

As depicted in FIG. 3B, the stair1 has two variations both of them consist of the convolutions.

The structure of stair2 is depicted in FIG. 3C, and there are two variations described as follows: when the kernel stride is 1, the channels of the input feature maps are split into two equal parts using the split operation. One part goes through an inverted residual structure with depth-wise separable convolutions, while the other part remains unchanged. After that, the two sets of channels are concatenated and then subjected to the shuffle operation; when the kernel stride is 2, the channels of the input feature maps are replicated into three copies. One copy goes through an inverted residual structure. Another copy goes through a depth-wise separable convolution followed by dimension reduction. The last copy goes through a max pooling operation followed by dimension reduction. Finally, the three sets of dimension-reduced channels are concatenated and then subjected to the shuffle operation.

The structure of stair3 is displayed in FIG. 3D. It is an inverted residual structure that includes depth-wise separable convolutions and efficient channel attention (ECA).

When building the backbone-Stair, the input feature map passed through the batch normalization layer (BN) is normalized using the following formula:

$$\begin{matrix}{μ}_{ℬ} = \frac{1}{m} {\sum }_{i = 1}^{m} {x}_{i} \\ {σ}_{ℬ}^{2} = \frac{1}{m} {\sum }_{i = 1}^{m} {( {x}_{i} - {μ}_{ℬ} )}^{2} \\ {\hat{x}}_{i} = \frac{{x}_{i} - {μ}_{ℬ}}{\sqrt{{σ}_{ℬ}^{2} + ϵ}} \\ {y}_{i} ← γ {\hat{x}}_{i} + β\end{matrix}$$

In the formula, xᵢ represents the input feature map to batch normalization, yᵢ represents the output feature map after Batch normalization, m represents the number of feature maps input to this layer, and γ and β are variables that vary with the gradient updates of the network.

When building the backbone-Stair, the data passed through the ReLU6 (RE) activation function in each layer is subjected to non-linear processing using the following formula:

ƒ(xᵢ)=min(max(xᵢ,0),6)

where xᵢ is the input data to the ReLU6 activation function, and ƒ(xᵢ) denotes the output data after the non-linear processing.

When building the backbone-Stair, the data passed through the Hardswish (HS) activation function in each layer is subjected to non-linear processing using the following formula:

$$f ( x ) = \{ \begin{matrix}0 & if x \leq - 3 \\ x & if x \geq + 3 \\ x \cdot ( x + 3 ) / 6 & otherwise\end{matrix}$$

where x is the input data to the Hardswish activation function, and ƒ(xᵢ) denotes the output data after the non-linear processing.

When building the backbone-Stair feature, the enhanced feature map of road cracks is obtained by using the following formula to perform cross-channel interaction on the data passed through the ECA in each layer:

$$k = ψ ( C ) = {\vert \frac{{log}_{2} ( C )}{γ} + \frac{b}{γ} \vert}_{odd} ,$$

$${E}_{s} ( F ) = σ ( {f}^{k * k} [ Avg Pool ( F ) ] )$$

where |t|_{odd} is the closest odd number to t. C is the number of channels in the input data for the ECA mechanism. γ and b are two hyperparameters, where γ is set to 2 and b is set to 1 in this patent. Eₛ(F) denotes the feature maps output from the ECA, σ denotes the sigmoid operation, ƒ^{k*k}[⋅] denotes the convolution operation with a k×k kernel, F refers to the input feature map, and avgPool( ) denotes average pooling operation.

When building the backbone-Stair, the following formula is used to apply the average pooling and max pooling to the channel attention module. This helps to compress the channel dimensions of the input feature maps and merge them by element-wise summation to generate the channel attention map.

M_{c}(F)=σ(MLP(AvgPool(F))+MLP(MaxPool(F)

where M_{c} denotes the output feature map after the channel attention process, MLP( ) denotes the fully connected layers, σ is sigmoid operation, F is the input feature map, AvgPool( ) is the average pooling operation, MaxPool( ) is the max pooling operation.

When building the backbone-Stair, the following formula is used to apply the average pooling and max pooling methods to the spatial attention module to compress the input feature map. This results in a feature extraction map that contains more information about important features:

Mₛ(F)=σ(ƒ⁷⁺⁷[AvgPool(F),MaxPool(F)])

where Mₛ denotes the output feature map after the spatial attention process, ƒ^{7*7}[⋅] denotes the 7×7 convolution operation.

The RPN in step 3 consists of the anchor generator and RPN head.

The anchor generator generates multiple sets of anchor boxes and assigns the anchor boxes to projected positions in the feature map of the original image.

The RPN head structure includes a 3×3 convolutional layer, two parallel 1×1 convolutional layer, and a ReLU activation function.

The training processes for the RPN head include passing the feature map obtained from the backbone-Stair through a 3×3 convolutional layer. The output of the 3×3 convolutional layer is then passed through the two parallel 1×1 convolutional layers and a ReLU activation function. The output of the two parallel convolution layers contains the target scores and regression parameters for all anchor boxes corresponding to each pixel point in the feature map.

The regression parameters output from the RPN head is used to adjust the anchor boxes to obtain the proposals, the formula of the process is as follows:

x=wₐtₓ+xₐ

y=hₐt_{y}+yₐ

w=wₐexp(t_{w})

h=hₐexp(tₕ)

where x, y, wand h denote the center coordinate (x, y), and the width and the height of the proposals; xₐ, yₐ, wₐ and hₐ denote the center coordinate (xₐ, yₐ), and the width and the height of the anchor boxes; tₓ, t_{y}, t_{w} and tₕ are the regression parameters predicted by the RPN head.

After generating the proposals, they are further filtered using algorithms such as non-maximum suppression. Then, the filtered proposals are projected onto the feature map obtained from the backbone-Stair to obtain the corresponding feature matrices.

The feature matrices are subjected to pooling operations for feature extraction, leading to their transformation into 7×7-sized feature maps.

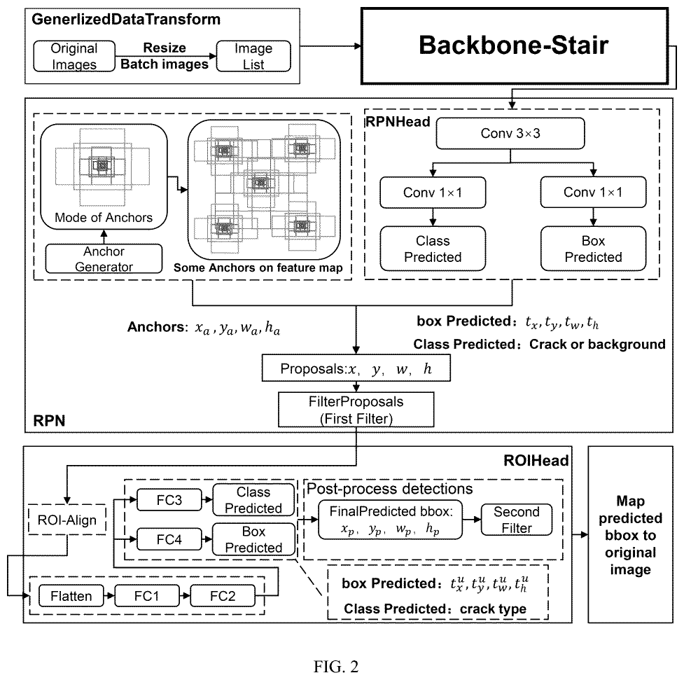

In the ROI head, the fully connected (FC) layer consists of two consecutive FC layers (FC1, FC2), as illustrated in FIG. 2. The 7×7-sized feature map is flattened and passed through these two FC layers. The output of FC2 is then fed into the two parallel FC layers (FC3, FC4), which are used for predicting the crack class scores and bounding box regression parameters for each proposal. The proposals are adjusted using the bounding box regression parameters from FC4 to obtain the final predicted results. The formula for calculating the final bounding box coordinates is as follows:

xₚ=wtₓ^{u}+x

yₚ=ht_{y}^{u}+y

wₚ=w·exp(t_{w}^{u})

hₚ=h·exp(tₕ^{u})

where xₚ, yₚ, wₚ and hₚ denote the center coordinate (xₚ, yₚ), and the width and the height of the final predicted bounding boxes; tₓ^{u}, t_{y}^{u}, t_{w}^{u} and tₕ^{u} are the regression parameters predicted by the ROI head.

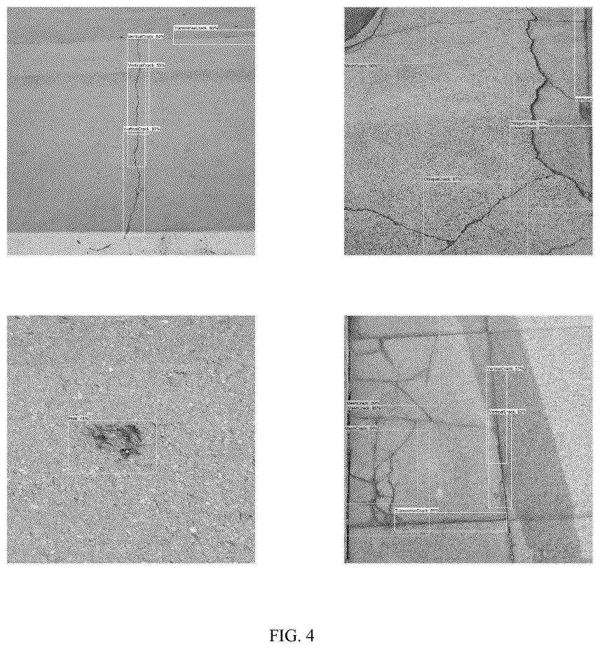

After the Faster R-Stair model is well-trained, the real-world road images are inputted into the model as the test set for road crack detection. some detection results are depicted in FIG. 4.

Referring to the training and detection process illustrated in the FIG. 1, in example 1, a comparison is made between the proposed Faster R-Stair model and the Faster R-CNN models using the traditional CNNs as backbones. The compared backbones include VGG16, ResNet34, and MobileNet_v3. After training for 20 epochs, these models are used for crack detection on a validation set of road crack images. The model size, training time, mean average precision (mAP), mean average recall (mAR), and frames per second (FPS) for each model are depicted in table 3.

TABLE 3
Detection results of the models.

| | Faster R- | | | | |
|---|---|---|---|---|---|
| Faster | CNN | | | IoU = 0.5 | |
| R-CNN | Model | Training | FPS | mAP | mAR |
| backbone | size(MB) | time(s) | (f/s) | (%) | (%) |
| Backbone- | 72 | 665.23 | 58 | 91.6 | 97.8 |
| Stair | | | | | |
| VGG16 | 334 | 5750.01 | 11 | 91.1 | 97.8 |
| Resnet | 260 | 1747.04 | 31 | 91.3 | 97.4 |
| 34 | | | | | |
| Mobile | 88 | 1950.02 | 15 | 91.0 | 97.9 |
| netV3 | | | | | |

Precision is the proportion of positive samples that are correctly predicted for all predicted positive samples. The higher the precision, the lower the probability of false alarms. mAP is the average of the precision for all classes in the sample. The formula for precision is as follows:

$$Precision = \frac{T P}{T P + F P}$$

Recall is the proportion of positive samples that are correctly predicted for all true positive samples. The higher the recall, the lower the probability of underreporting. mAR is the average of the recall for all classes in the sample The recall calculation formula is as follows:

$$Recall = \frac{T P}{T P + F N}$$

The definitions for TP, FP, and FN are different from those of the classification task and are as follows:
TP: Number of prediction boxes that has IoU higher than 0.5 with the corresponding GT box.
FP: Number of prediction boxes that has IoU lower than 0.5 with the corresponding GT box.
FN: Number of GT boxes not detected.
The IoU is calculated as follows:

$$IoU = \frac{area ( A ) ⋂ area ( G )}{area ( A ) ⋃ area ( G )}$$

where (A) and (G) are the areas of the corresponding bounding box.

According to Table 3, the Faster R-Stair model achieves optimal efficiency compared to the other models. Its model size, training time, and FPS are 72 MB, 665.23 s and 58 f/s, respectively. Compared to Faster R-CNN models using VGG16, Resnet34, and MobilenetV3 backbones, Faster R-Stair has reduced model sizes by 78.44, 72.31, and 18.18% respectively; training times have been reduced by 88.43, 61.93, and 65.90% respectively, and FPS has increased by 81.03, 46.55, and 74.14% respectively.

The above embodiments are only preferred embodiments of the present embodiment, and the scope of protection of the present embodiment is not limited thereto. Any person skilled in the art can readily derive various simple modifications or equivalent substitutions of the technical solutions within the technical scope disclosed in the present embodiment, which should also be encompassed by the protection scope of the present embodiment.

What is claimed is:

1. A method for fast detecting road cracks in images using a depth-stage dependent and hyperparameter-adaptive lightweight CNN-based model, comprising the following steps:
the original images of road surface are collected and a dataset is established, including a training set and a validation set;
the images from the dataset are inputted into the backbone (backbone-Stair) to obtain feature maps, the backbone is depth-stage dependent, which includes suitable structures in different depths: convolutional layer, stair1, a convolution block attention module (CBAM), stair2, another CBAM, and stair3, the basic components in stair1 and stair2 have some variations according to the adjustment of some hyperparameters;
stair1 has two variations as follows: when the expansion factor is 1, the input feature maps go through an inverted residual structure with convolutions; when the expansion factor is not 1, the input feature maps go through a convolutional operation;
stair2 has two variations as follows: when the kernel stride is 1, the channels of the input feature maps are split into two equal parts using the split operation, one part goes through an inverted residual structure with depth-wise separable convolutions, while the other part remains unchanged, after that, the two sets of channels are concatenated and then subjected to the shuffle operation; when the kernel stride is 2, the channels of the input feature maps are replicated into three copies, one copy goes through an inverted residual structure, another copy goes through a depth-wise separable convolution followed by dimension reduction, the last copy goes through a max pooling operation followed by dimension reduction, finally, the three sets of dimension-reduced channels are concatenated and then subjected to the shuffle operation;
stair3 consists of a residual structure consisting of depth separable convolution and efficient channel attention (ECA); and
the feature maps obtained from the backbone are inputted to a region proposal network (RPN) to generate proposals, the proposals are projected onto the feature maps outputted by backbone to obtain corresponding feature matrices, the feature matrix is passed through a region of interest (ROI) head to output predicted bounding boxes of the road cracks in the feature maps, the predicted bounding boxes of the road cracks in the feature maps are mapped back to the original image using post-processing to obtain the positions and types of road cracks in the original image.

2. The method according to claim 1, wherein a feature of the method for fast detecting road cracks using the Faster R-Stair model is that the input feature map passed through the batch normalization layer (BN) is normalized using the following formula:
$$\begin{matrix}{μ}_{ℬ} = \frac{1}{m} {\sum }_{i = 1}^{m} {x}_{i} \\ {σ}_{ℬ}^{2} = \frac{1}{m} {\sum }_{i = 1}^{m} {( {x}_{i} - {μ}_{ℬ} )}^{2} \\ {\hat{x}}_{i} = \frac{{x}_{i} - {μ}_{ℬ}}{\sqrt{{σ}_{ℬ}^{2} + ϵ}} \\ {y}_{i} ← γ {\hat{x}}_{i} + β\end{matrix}$$
where in the formula, xᵢ represents the input feature map to batch normalization, yᵢ represents the output feature map after Batch normalization, m represents the number of feature maps input to this layer, and γ and β are variables that vary with the gradient updates of the network.

3. The method according to claim 1, wherein a feature of the method for fast detecting road cracks using the Faster R-Stair model is that the data passes through a ReLU6 (RE) activation function in each layer and is subjected to non-linear processing using the following formula:
ƒ(xᵢ)=min(max(xᵢ,0),6)
where xᵢ is the input data to the ReLU6 activation function, and ƒ(xᵢ) denotes the output data after the non-linear processing.

4. The method according to claim 1, wherein a feature of the method for fast detecting road cracks using the Faster R-Stair model is that the data passes through a Hardswish (HS) activation function in each layer and is subjected to non-linear processing using the following formula:
$$f ( x ) = \{ \begin{matrix}0 & if x \leq - 3 \\ x & if x \geq + 3 \\ x \cdot ( x + 3 ) / 6 & otherwise\end{matrix}$$
where x is the input data to the Hardswish activation function, and ƒ(x) denotes the output data after the non-linear processing.

5. The method according to claim 1, wherein a feature of the method for fast detecting road cracks using the Faster R-Stair model is that the enhanced feature map of road cracks is obtained by using the following formula to perform cross-channel interaction on the data passed through the ECA in each layer:
$$k = ψ ( C ) = {\vert \frac{{log}_{2} ( C )}{γ} + \frac{b}{γ} \vert}_{odd} ,$$
$${E}_{s} ( F ) = σ ( {f}^{k * k} [ Avg Pool ( F ) ] )$$
where |t|_{odd} is the closest odd number to t, C is the number of channels in the input data for the ECA mechanism, γ and b are two hyperparameters, where y is set to 2 and b is set to 1 in this patent, Eₛ(F) denotes the feature maps output from the ECA, σ denotes the sigmoid operation, ƒ^{k*k}[⋅] denotes the convolution operation with a k×k kernel, F refers to the input feature map, and avgPool( ) denotes average pooling operation.

6. The method according to claim 1, wherein a feature of the method for fast detecting road cracks using the Faster R-Stair model is that the CBAM is utilized in the backbone for enhancing the feature extraction capability, containing the channel attention and spatial attention modules;
the following formula is used to apply the average pooling and max pooling to the channel attention module, this helps to compress the channel dimensions of the input feature maps and merge them by element-wise summation to generate the channel attention map,
M_{c}(F)=σ(MLP(AvgPool(F))+MLP(MaxPool(F)
where M_{c} denotes the output feature map after the channel attention process, MLP( ) denotes the fully connected layers, σ is sigmoid operation, F is the input feature map, AvgPool( ) is the average pooling operation, MaxPool( ) is the max pooling operation;
the following formula is used to apply the average pooling and max pooling methods to the spatial attention module to compress the input feature map, this results in a feature extraction map that contains more information about important features:
Mₛ(F)=σ(ƒ^{7*7}[AvgPool(F),MaxPool(F)])
where Mₛ denotes the output feature map after the spatial attention process, ƒ^{7*7}[⋅] denotes the 7×7 convolution operation.

7. The method according to claim 1, wherein a feature of the method for fast detecting road cracks using the Faster R-Stair model is that the RPN consists of anchor generator and RPN head, the anchor generator generates multiple sets of anchor boxes and the RPN head structure includes a 3×3 convolutional layer, two parallel 1×1 convolutional layer, and a ReLU activation function, the training processes for the RPN head include passing the feature map obtained from the backbone through a 3×3 convolutional layer, the output of the 3×3 convolutional layer is then passed through the two parallel 1×1 convolutional layers and a ReLU activation function, the output of the two parallel convolution layers contains the target scores and regression parameters for all anchor boxes corresponding to each pixel point in the feature map:
cls=[Crack probability]
tᵢ=[tₓ,t_{y},t_{w},tₕ]
where cls is the target score representing the crack probability predicted by the RPN head and t; is the regression parameter of the ith anchor box predicted by the RPN head;
the regression parameters output from the RPN head is used to adjust the anchor boxes to obtain the proposals, the formula of the process is as follows:
x=wₐtₓ+xₐ
y=hₐt_{y}+yₐ
w=wₐexp(t_{w})
h=hₐexp(tₕ)
where x, y, wand h denote the center coordinate (x, y), and the width and the height of the proposals; xₐ, yₐ, wₐ and hₐ denote the center coordinate (xₐ, yₐ), and the width and the height of the anchor boxes; tₓ, t_{y}, t_{w} and tₕ are the regression parameters predicted by the RPN head.

8. The method according to claim 7, wherein a feature of the method for fast detecting road cracks using the Faster R-Stair model is that the loss of the RPN head is calculated as follows:
$$Loss ( \{ {p}_{i} \} , \{ {t}_{i} \} ) = \frac{1}{{N}_{c l s}} {\sum }_{i} {L}_{c l s} ( {p}_{i} , {p}_{i}^{*} ) + λ \frac{1}{{N}_{r e g}} {\sum }_{i} {p}_{i}^{*} {L}_{r e g} ( {t}_{i} , {t}_{i}^{*} )$$
$${L}_{c l s} ( {p}_{i} , {p}_{i}^{*} ) = - [ {p}_{i}^{*} log ( {p}_{i} ) + ( 1 - {p}_{i}^{*} ) log ( 1 - {p}_{i} ) ]$$
$${L}_{r e g} ( {t}_{i} , {t}_{i}^{*} ) = {\sum }_{i} {smooth}_{{L}_{1}} ( {t}_{i} - {t}_{i}^{*} )$$
$${Smooth}_{{L}_{1}} ( x ) = \{ \begin{matrix}0.5 {x}^{2} & if \vert x \vert < 1 \\ \vert x \vert - 0.5 & otherwise\end{matrix}$$
where Loss({pᵢ}, {tᵢ}) denotes the loss of the RPN head, which is composed of the loss of class classification L_{cls}(pᵢ, p*ᵢ) and loss of regression parameters L_{reg}(tᵢ, t*ᵢ); pᵢ is the probability that the ith anchor is predicted as the target; p*ᵢ is 1 when the anchor is positive while it is 0 when negative; tᵢ is the regression parameter of the ith anchor box whereas t; is the regression parameter of the GT box corresponding to the ith anchor; N_{cls} is the number of all samples in a mini-batch; N_{reg} is the number of anchor positions; and A is used to balance the loss of class classification and loss of boundary box regression.

9. The method according to claim 1, wherein a feature of the crack detection method using the Faster R-Stair model is that the ROI head consists of ROI pooling, fully connected layer and postprocess detections, the feature maps are pooled and transformed into 7×7-sized feature maps by ROI pooling, the fully connected layer structure consists of two concatenated fully connected layers (FC1, FC2), where the feature maps pass through the two fully connected layers and then into two parallel fully connected layers (FC3, FC4) for predicting crack class scores and regression parameters for each proposal, similar to the steps in RPN, the losses of the fully connected layers should be calculated as follows:
$$( p , u , {t}^{u} , v ) = {L}_{c l s} ( p , u ) + λ [ u \geq 1 ] {L}_{l o c} ( {t}^{u} , v )$$
$${L}_{c l s} ( p , u ) = - log {p}_{u}$$
$${L}_{l o c} ( {t}^{u} , v ) = {\sum }_{i ∈ \{ x , y , w , h \}} {smooth}_{{L}_{1}} ( {t}_{i}^{u} - {v}_{i} )$$
where Loss(p, u, t^{u}, v) denotes the loss of a fully connected layer in the ROI head, which comprises the loss of crack classification and loss of regression parameters; p is the softmax probability predicted by the classifier; u is the label of a real class of target; t^{u} is the regression parameter predicted by FC4, which is (tₓ^{u}, t_{y}^{u}, t_{w}^{u}, tₕ^{u}); v is the regression parameter of the GT box corresponding to the real target, which is (vₓ, v_{y}, v_{w}, vₕ); [u≥1] denotes the Iverson bracket; the Adam algorithm is used to optimise the internal parameters of the model,
The formula for calculating the final bounding box coordinates is as follows:
xₚ=wtₓ^{u}+x
yₚ=ht_{y}^{u}+y
wₚ=w·exp(t_{w}^{u})
hₚ=h·exp(tₕ^{u})
where xₚ, yₚ, wₚ and hₚ denote the center coordinate (xₚ, yₚ), and the width and the height of the final predicted bounding boxes; tₓ^{u}, t_{y}^{u}, t_{w}^{u} and tₕ^{u} are the regression parameters predicted by the ROI head.

10. The method according to claim 9, wherein a feature of the crack detection method using the Faster R-Stair model is that the internal parameters of the network are optimized using the Adam algorithm:
ƒ(θ)=Loss
gₜ=∇_{θ}ƒₜ(θₜ₋₁)
mₜ=β₁·mₜ₋₁+(1−β₁)·gₜ
vₜ=β₂·vₜ₋₁+(1−β₂)·gₜ²
\hat{m}ₜ=mₜ/(1−β₁^{t})
\hat{v}ₜ=vₜ/(1−βₜ²)
θₜ=θₜ₋₁−α·\hat{m}ₜ/(\sqrt{\hat{v}ₜ}+∈)
where Loss refers to the loss function of the RPN or ROI Head network, θ represents the parameters to be updated in the model, gₜ denotes the gradient of the loss function ƒ(θ) with respect to θ. β₁ is the first-order moment decay coefficient, β₂ is the second-order moment decay coefficient, mₜ represents the expected value of the gradient gₜ, and vₜ represents the expected value of gₜ², \hat{m}ₜ is the bias correction of mₜ, and \hat{v}ₜ is the bias correction of vₜ. θₜ₋₁ refers to the parameters before the network update, and θₜ refers to the parameters after the network update. α represents the learning rate.
